(19) United States
(12) Patent Application Publication
(10) Pub. No.: US 2025/0262879 A1
(43) Pub. Date: Aug. 21, 2025

(54) LIQUID EJECTING HEAD AND LIQUID EJECTING APPARATUS

(71) Applicant: SEIKO EPSON CORPORATION, Tokyo (JP)

(72) Inventors: Ken YAMAGISHI, SHIOJIRI-SHI (JP); Taichi YOKOYAMA, SHIOJIRI-SHI (JP)

(21) Appl. No.: 19/056,153

(22) Filed: Feb. 18, 2025

(30) Foreign Application Priority Data
Feb. 19, 2024 (JP) 2024-022638

(51) Int. Cl. B41J 25/34; B41J 2/14; B41J 2/175

(52) U.S. Cl. CPC B41J 25/34; B41J 2/14233; B41J 2/1433; B41J 2/17523; B41J 2202/20

(57) ABSTRACT

A liquid ejecting head includes: a head module that includes a flow path opening forming member and a chip; a supply flow path member that supplies a liquid to the head module; an elastic sealing member that liquid-tightly couples the flow path opening forming member and the supply flow path member to each other; and a fixing member that fixes the supply flow path member and the flow path opening forming member, in which a sealing region sandwiched between the flow path opening forming member and the supply flow path member in the sealing member overlaps the chip when viewed in an ejection direction, and a dimension of a portion of the flow path opening forming member that overlaps the sealing region in the ejection direction is larger than a distance between the sealing region and the fixing member when viewed in the ejection direction.

The present application is based on, and claims priority from JP Application Serial Number 2024-022638, filed Feb. 19, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

A liquid ejecting apparatus that includes a liquid ejecting head that ejects a liquid such as ink onto a medium such as printing paper has been proposed.

A liquid ejecting head described in JP-A-2015-226988 includes a recording element unit (head module) including an element recording substrate that includes an ejection port for ejecting a liquid and a support member that fixes the element recording substrate, and a flow path unit (supply flow path member) including a liquid supply path for supplying the liquid to the recording element unit, and the recording element unit and the flow path unit are liquid-tightly coupled to each other via an elastic member (sealing member).

When the sealing member is sandwiched between the head module and the supply flow path member to liquid-tightly couple a flow path, there is a possibility that reliability of the head module decreases due to a reaction force of the sealing member.

### SUMMARY

According to an aspect of the present disclosure, a liquid ejecting head includes: a first head module that ejects a liquid in a first direction and includes a first flow path opening forming member in which a first flow path opening is formed, and a first chip disposed in the first direction with respect to the first flow path opening forming member; a supply flow path member that supplies the liquid to the first head module; an elastic first sealing member that is sandwiched between the first head module and the supply flow path member in the first direction to liquid-tightly couple the first flow path opening and a flow path opening of the supply flow path member to each other; and a first fixing member that fixes the supply flow path member and the first flow path opening forming member, in which a first sealing region sandwiched between the first flow path opening forming member and the supply flow path member in the first sealing member overlaps the first chip when viewed in the first direction, and a first dimension of a portion of the first flow path opening forming member that overlaps the first sealing region in the first direction is larger than a first distance between the first sealing region and the first fixing member when viewed in the first direction.

According to an aspect of the present disclosure, a liquid ejecting apparatus includes: a plurality of liquid ejecting heads; and a unit base to which the plurality of liquid ejecting heads are fixed.

### BRIEF DESCRIPTION OF THE DRAWINGS

FIG. 1 is a schematic view illustrating a configuration of a liquid ejecting apparatus according to a first embodiment.

FIG. 2 is a cross-sectional view of a liquid ejecting head illustrated in FIG. 1.

FIG. 3 is a bottom view of the liquid ejecting head illustrated in FIG. 2.

FIG. 4 is a cross-sectional view of a chip of a head module illustrated in FIG. 2.

FIG. 5 is a view illustrating the head module, a supply flow path member, and a sealing member illustrated in FIG. 2.

FIG. 6 is a plan view of the head module and the sealing member illustrated in FIG. 2.

FIG. 7 is a plan view of a sealing member and a fixing member according to a first modified example.

FIG. 8 is a cross-sectional view of the sealing member and the fixing member according to the first modified example.

FIG. 9 is a plan view of a sealing member and a fixing member according to a second modified example.

FIG. 10 is a cross-sectional view of the sealing member and the fixing member according to the second modified example.

FIG. 11 is a plan view of a sealing member and a fixing member according to a third modified example.

FIG. 12 is a plan view of a sealing member and a fixing member according to a fourth modified example.

FIG. 13 is a plan view of a sealing member and a fixing member according to a fifth modified example.

FIG. 14 is a cross-sectional view of a sealing member and a fixing member according to a sixth modified example.

FIG. 15 is a plan view of a head module according to the sixth modified example.

FIG. 16 is a plan view of a sealing member and a fixing member according to a seventh modified example.

FIG. 17 is a cross-sectional view of the sealing member and the fixing member according to the seventh modified example.

FIG. 18 is a plan view of a head module according to an eighth modified example.

FIG. 19 is a cross-sectional view of the head module according to the eighth modified example.

FIG. 20 is a cross-sectional view of a head module according to a ninth modified example.

FIG. 21 is a cross-sectional view of a sealing member and the vicinity thereof according to a tenth modified example.

FIG. 22 is a cross-sectional view of a sealing member and the vicinity thereof according to an eleventh modified example.

### DESCRIPTION OF EMBODIMENTS

Hereinafter, exemplary embodiments according to the present disclosure will be described with reference to the accompanying drawings. Note that the dimensions or the scale of each component may differ appropriately from actual dimensions or scales, and some portions are schematically illustrated in the drawings to facilitate understanding. Further, the scope of the present disclosure is not limited to the embodiments unless otherwise specified in the following description. Furthermore, the phrase “an element β on an element γ” is not limited to a configuration in which the element γ and the element β are in direct contact with each other, but also includes a configuration in which the element γ and the element β are not in direct contact with each other. The phrase “the element γ and the element β are equal to each other” means that the element γ and the element β are only required to be substantially equal to each other, and includes measurement errors, manufacturing errors, and the like. The phrase “the element γ and the element β are the same as each other” means that the element γ and the element β are only required to be substantially the same as each other, and includes measurement errors, manufacturing errors, and the like.

### 1. First Embodiment

### 1-1. Overall Configuration of Liquid Ejecting Apparatus 100

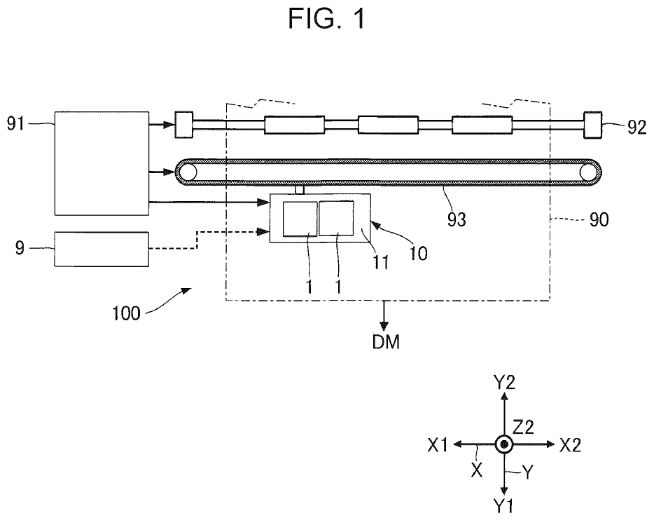

FIG. 1 is a schematic view illustrating a configuration of a liquid ejecting apparatus 100 according to a first embodiment. In the following, for convenience of explanation, an X axis, a Y axis, and a Z axis that are orthogonal to one another are used as appropriate. Further, a direction along the X axis is referred to as an X1 direction, and a direction opposite to the X1 direction is referred to as an X2 direction. Similarly, a direction along the Y axis is referred to as a Y1 direction, and a direction opposite to the Y1 direction is referred to as a Y2 direction. A direction along the Z axis is referred to as a Z1 direction, and a direction opposite to the Z1 direction is referred to as a Z2 direction. The Z1 direction corresponds to a “first direction”. Furthermore, the Z1 direction with respect to a certain point is defined as a “downward direction”, and the Z2 direction from the certain point is defined as an “upward” direction. Further, viewing in the Z1 direction or the Z2 direction is referred to as “plan view”.

As illustrated in FIG. 1, the liquid ejecting apparatus 100 includes a liquid storage section 9, a control unit 91, a transport section 92, a head unit 10, and a movement mechanism 93.

The liquid storage section 9 is a container that stores ink. Specific aspects of the liquid storage section 9 include, for example, a cartridge that is attachable to and detachable from the liquid ejecting apparatus 100, a bag-shaped ink pack made of a flexible film, and an ink tank that can be refilled with the ink. The type of the ink stored in the liquid storage section 9 is not particularly limited but is arbitrary.

The control unit 91 controls an operation of each element of the liquid ejecting apparatus 100. The control unit 91 includes, for example, a processing circuit such as a central processing unit (CPU) or a field programmable gate array (FPGA), and a storage circuit such as a semiconductor memory, and controls an operation of each element of the liquid ejecting apparatus 100.

The transport section 92 transports a medium 90 in a direction DM under the control of the control unit 91. The direction DM in the present embodiment is the Y1 direction. In the example illustrated in FIG. 1, the transport section 92 includes a transport roller that is elongated along the X axis and a motor that rotates the transport roller. The transport section 92 is not limited to a configuration using the transport roller, and may be configured to use, for example, a drum or an endless belt that transports the medium 90 while adsorbing the medium 90 to an outer circumferential surface thereof by an electrostatic force or the like.

The head unit 10 includes a unit base 11 and a liquid ejecting head 1. The liquid ejecting head 1 ejects the ink from a nozzle N toward the medium 90. The unit base 11 holds the liquid ejecting head 1.

The movement mechanism 93 includes a transport belt to which the unit base 11 of the head unit 10 is fixed, and reciprocates the head unit 10 in the X1 direction and the X2 direction under the control of the control unit 91. The head unit 10 ejects the ink supplied from the liquid storage section 9 onto the medium 90 through each of a plurality of nozzles N in the Z1 direction under the control of the control unit 91. The ejection of the ink from the head unit 10 is performed in parallel with the movement of the head unit 10 by the movement mechanism 93, so that an image is formed with the ink on the surface of the medium 90.

The number and arrangement of a plurality of liquid ejecting heads 1 included in the head unit 10 are not limited to those in the example illustrated in FIG. 1 but are arbitrary. In addition, when the head unit 10 is configured to be able to circulate the ink, the head unit 10 may be coupled to the liquid storage section 9 via a circulation mechanism for circulating the ink in the head unit 10.

As described above, the liquid ejecting apparatus 100 includes the plurality of liquid ejecting heads 1 and the unit base 11 to which the plurality of liquid ejecting heads 1 are fixed. Such a liquid ejecting apparatus 100 includes the liquid ejecting head 1 as described below. As described below, each of the plurality of liquid ejecting heads 1 is less susceptible to defects such as warping, and has excellent reliability in print quality. Therefore, with the liquid ejecting apparatus 100 including the plurality of liquid ejecting heads 1, it is possible to improve the reliability in print quality.

### 1-2. Liquid Ejecting Head 1

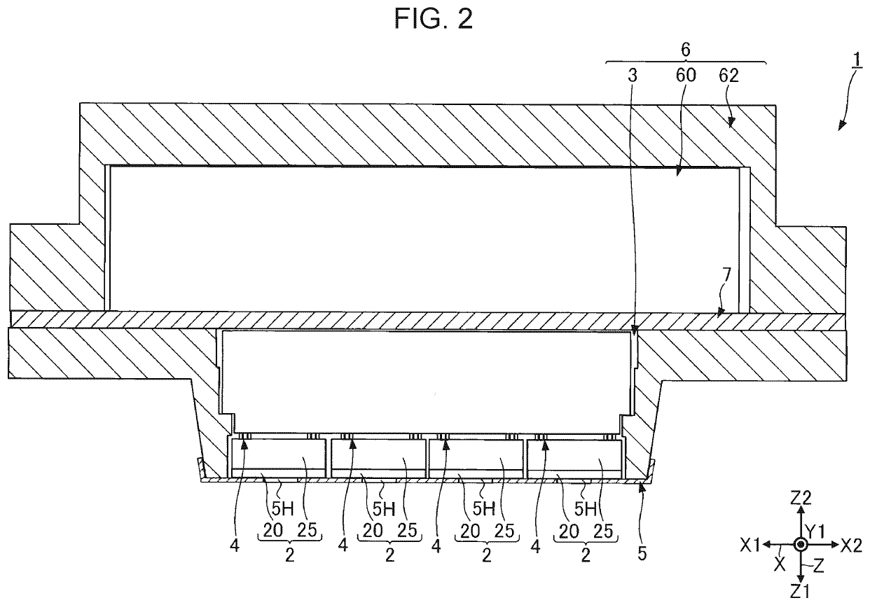

FIG. 2 is a cross-sectional view of the liquid ejecting head 1 illustrated in FIG. 1. As illustrated in FIG. 2, the liquid ejecting head 1 includes a plurality of head modules 2, a plurality of sealing members 4, a cover 5, a flow path unit 6, and a relay substrate 7. The flow path unit 6 includes a supply flow path member 3, a flow path member 60, and a case 62. The flow path unit 6 may be regarded as a “supply flow path member”.

Each of the plurality of head modules 2 includes the plurality of nozzles N. Each of the plurality of head modules 2 ejects the ink in the Z1 direction, which is the “first direction”. The plurality of head modules 2 are arranged along the X axis. Each head module 2 is a member that is elongated along the Y axis. In the illustrated example, the number of head modules 2 is four, but the number of head modules 2 is not limited thereto and may be one to three, or five or more. Each head module 2 includes a chip 20 and a flow path opening forming member 25. The chip 20 includes the plurality of nozzles N that eject the ink. The flow path opening forming member 25 is positioned in the Z2 direction with respect to the chip 20 and supplies the ink to the chip 20. The flow path opening forming member 25 and the chip 20 are fixed to each other with, for example, an adhesive or the like. For example, the flow path opening forming member 25 may be a member having a thickness of 3000 μm or more, a member having a thickness of 5000 μm or more, or a member having a thickness of 8000 μm or more. The flow path opening forming member 25 may be formed using one member or may be formed by stacking a plurality of members. The flow path opening forming member 25 may be made of a resin or may be made of a metal. Further, the flow path opening forming member 25 may contain a resin and a metal.

The supply flow path member 3 is positioned in the Z2 direction with respect to the plurality of head modules 2. The supply flow path member 3 is common to the plurality of head modules 2. The supply flow path member 3 includes a supply flow path for supplying the ink to each head module 2. The supply flow path is a flow path common to the plurality of head modules 2. A material of the supply flow path member 3 is, for example, a resin or a metal such as stainless steel.

The plurality of sealing members 4 are disposed between each head module 2 and the supply flow path member 3. The plurality of sealing members 4 are provided for each head module 2. The sealing member 4 is sandwiched between the head module 2 and the supply flow path member 3 in the Z1 direction and is compressed by the head module 2 and the supply flow path member 3. The plurality of sealing members 4 are members that liquid-tightly couple flow paths between each head module 2 and the supply flow path member 3. The sealing member 4 has elasticity. A material of the sealing member 4 is, for example, an elastic material such as an elastomer. In the present embodiment, a length of the sealing member 4 along the Z axis, that is, a thickness, is uniform. The thickness of the sealing member 4 is smaller than a thickness of the flow path opening forming member 25.

The supply flow path member 3 houses and holds the plurality of head modules 2. The supply flow path member 3 has a recess formed in the Z2 direction on a bottom surface facing the Z1 direction, and the plurality of head modules 2 are disposed in an internal space formed inside the recess.

The cover 5 is a flat-plate-shaped member provided in the Z1 direction with respect to the plurality of head modules 2, and holds the plurality of head modules 2 together with the supply flow path member 3. A material of the cover 5 is, for example, a metal such as stainless steel. Further, the cover 5 has an opening 5H, which is a through-hole formed for each head module 2.

The relay substrate 7 is a substrate on which mounted components that electrically couple the above-described control unit 71 and a wiring substrate 209 (described below) provided on each head module 2 to each other are mounted. The relay substrate 7 has a flat plate shape along an X-Y plane and is disposed between the supply flow path member 3 and the case 62. Although not illustrated, the relay substrate 7 has a through-hole communicating with the flow path of the supply flow path member 3.

The flow path member 60 is disposed in the Z2 direction with respect to the relay substrate 7. The flow path member 60 includes a flow path for supplying the ink to the flow path of the supply flow path member 3 through the through-hole provided in the relay substrate 7. A material of the flow path member 60 is, for example, a resin.

The case 62 is a member that houses the flow path member 60. The case 62 has a hole that penetrates along the Z axis, and the flow path member 60 is disposed in an internal space formed inside the hole. Although not illustrated, the case 62 is coupled to the supply flow path member 3 and holds the supply flow path member 3. A method of coupling the case 62 and the supply flow path member 3 to each other is not particularly limited. The case 62 and the supply flow path member 3 may be coupled to each other using any member such as an adhesive, a screw, or an engagement member. Although not illustrated, the case 62 has an opening through which a wiring member for electrically coupling the relay substrate 7 and the control unit 91 is inserted. Although not illustrated, the case 62 has a through-hole for supplying the ink to the flow path member 60 from the liquid storage section 9. A material of the case 62 is, for example, a resin or a metal such as aluminum or stainless steel.

The liquid ejecting head 1 in FIG. 2 described above is an example. The liquid ejecting head 1 according to the present embodiment includes all the elements illustrated in FIG. 2, but the components of the liquid ejecting head 1 do not need to include all the elements, and may further include additional elements.

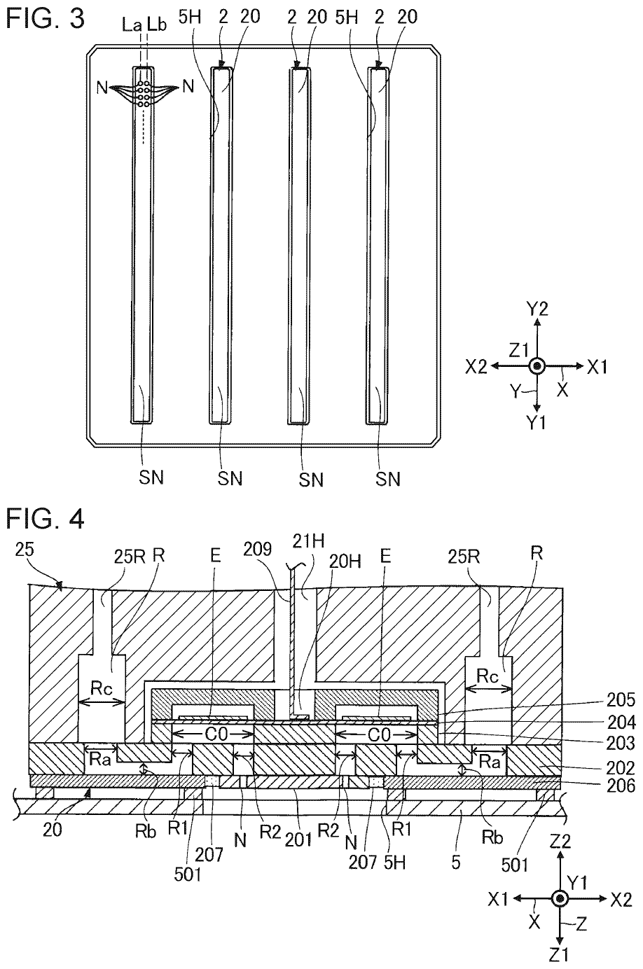

FIG. 3 is a bottom view of the liquid ejecting head 1 illustrated in FIG. 2. As illustrated in FIG. 3, the plurality of nozzles N of the head module 2 are exposed through the opening 5H of the cover 5. The plurality of nozzles N of each head module 2 are arranged along the Y axis. The plurality of nozzles N are divided into nozzle rows La and Lb arranged in parallel at an interval along the X axis. Each of the nozzle rows La and Lb is a set of nozzles N arranged in a straight line along the Y axis. A surface of the head module 2 on which openings of the plurality of nozzles N are formed is referred to as a nozzle surface SN. The nozzle surface SN is a surface of the chip 20 of the head module 2 that faces the Z1 direction. For example, the plurality of nozzles N may be arranged in a direction intersecting the X axis and the Y axis when viewed in the Z1 direction.

### 1-3. Chip 20

FIG. 4 is a cross-sectional view of the chip 20 of the head module 2 illustrated in FIG. 2. As illustrated in FIG. 4, the chip 20 is disposed in the Z1 direction with respect to the flow path opening forming member 25. The chip 20 has a structure in which elements related to each nozzle N of the nozzle row La and elements related to each nozzle N of the nozzle row Lb are arranged in approximate plane symmetry. Hereinafter, when there is no need to distinguish between the nozzle row La and the nozzle row Lb, the nozzle row La and the nozzle row Lb will be referred to as nozzle row L. In the following description, a configuration corresponding to the nozzles N of one nozzle row La or Lb will be mainly described.

As illustrated in FIG. 4, the chip 20 of each head module 2 includes, for example, a communication plate 202, a pressure chamber substrate 203, a diaphragm 204, a nozzle plate 201, a vibration absorber 206, a plurality of driving elements E, and a sealing substrate 205.

Each of the communication plate 202, the pressure chamber substrate 203, the diaphragm 204, the nozzle plate 201, and the vibration absorber 206 is a plate-shaped member that is elongated along the Y axis. The pressure chamber substrate 203 is installed on a surface of the communication plate 202 in the Z2 direction. The nozzle plate 201 and the vibration absorber 206 are installed on a surface of the communication plate 202 in the Z1 direction. For example, the respective members are fixed to each other with an adhesive.

The nozzle plate 201 is a plate-shaped member in which the plurality of nozzles N are formed. The nozzle plate 201 is a member positioned furthest in the Z1 direction in the head module 2. A surface of the nozzle plate 201 that faces the Z1 direction is the nozzle surface SN. Each of the plurality of nozzles N is a circular through-hole through which the ink is ejected. For example, the nozzle plate 201 is manufactured by processing a silicon (Si) single crystal substrate using semiconductor manufacturing techniques such as photolithography and etching.

The communication plate 202 includes a plurality of throttling portions R1, a plurality of communication flow paths R2, a communication space Ra, and a common flow path Rb. Each of the throttling portions R1 and the communication flow paths R2 extends in the Z1 direction and is a through-hole formed for each nozzle N. The communication flow path R2 overlaps the nozzle N in plan view. The communication space Ra is an opening formed so as to be elongated along the Y axis. The communication space Ra extends along the Y axis. The common flow path Rb communicates with the communication space Ra and overlaps the communication space Ra in plan view. The common flow path Rb extends along the Y axis. The common flow path Rb communicates with the plurality of throttling portions R1. The communication space Ra also communicates with a space Rc of the flow path opening forming member 25.

The communication space Ra, the common flow path Rb, and the space Rc form a common space R common to the plurality of nozzles N. The common space R functions as an ink reservoir. The ink stored in the common space R branches into the throttling portions R1 and is supplied to and filled in parallel into a plurality of pressure chambers C0.

The plurality of pressure chambers C0 are formed in the pressure chamber substrate 203. The pressure chamber C0 is a space positioned between the communication plate 202 and the diaphragm 204 and formed by a wall surface of the pressure chamber substrate 203. The pressure chamber C0 is formed for each nozzle N. The pressure chamber C0 is an elongated space extending in the X1 direction. The plurality of pressure chambers C0 are arranged along the Y axis.

The communication plate 202 and pressure chamber substrate 203 are manufactured by processing a semiconductor substrate such as a silicon single crystal substrate.

The elastically deformable diaphragm 204 is disposed on the pressure chamber C0. The diaphragm 204 is stacked on the pressure chamber substrate 203 and is in contact with a surface of the pressure chamber substrate 203 that is opposite to the communication plate 202. The diaphragm 204 is a plate-shaped member having a rectangular shape that is elongated along the Y axis in plan view. The pressure chamber C0 communicates with the communication flow path R2 and the throttling portion R1. Therefore, the pressure chamber C0 communicates with the nozzle N through the communication flow path R2 and communicates with the communication space Ra through the throttling portion R1. The nozzle N, the communication flow path R2, the pressure chamber C0, and the throttling portion R1 form an individual flow path for each nozzle N. For ease of explanation, the pressure chamber substrate 203 and the diaphragm 204 are illustrated as separate substrates in FIG. 4, but in actual implementation, the pressure chamber substrate 203 and the diaphragm 204 are stacked as a single silicon substrate.

The driving element E is formed for each pressure chamber C0 on a surface of the diaphragm 204 that is opposite to the pressure chamber C0. The driving element E is a piezoelectric element that is elongated along the X axis in plan view. The driving element E includes, for example, a pair of electrodes and a piezoelectric body sandwiched between the pair of electrodes. The driving element E may be an electrothermal conversion element that generates thermal energy.

The sealing substrate 205 is a structure that protects the plurality of driving elements E. The sealing substrate 205 is fixed to a surface of the diaphragm 204 with, for example, an adhesive. The plurality of driving elements E are housed inside a recess formed on a surface of the sealing substrate 205 that faces the diaphragm 204. Further, the sealing substrate 205 also has a through-hole 21H for inserting the wiring substrate 209.

The wiring substrate 209 is bonded to the diaphragm 204. The wiring substrate 209 protrudes from the diaphragm 204 in the Z2 direction. The wiring substrate 209 is a mounted component on which a plurality of wirings for electrically coupling the chip 20 and the relay substrate 7 are formed. The wiring substrate 209 is, for example, a flexible substrate such as a flexible printed circuit (FPC) or a chip on film (COF), or a rigid substrate. A drive signal and a reference voltage for driving the driving element E are supplied from the wiring substrate 209 to each driving element E.

The vibration absorber 206 is a thin metal plate that forms a wall surface of the common flow path Rb. The vibration absorber 206 has a thickness similar to that of the nozzle plate 201. A planar shape of the vibration absorber 206 is, for example, a frame shape that surrounds the nozzle plate 201. A mold 207 made of a resin is provided between the vibration absorber 206 and the nozzle plate 201. The vibration absorber 206 is a flexible film forming a wall surface of the communication space Ra, and absorbs variation in pressure of the ink in the common space R. As the vibration absorber 206 is provided, a natural frequency of a flow path from the nozzle N to the throttling portion R1 through the pressure chamber C0 is stabilized regardless of the driven nozzle N. In addition, a frame 501 is bonded between the vibration absorber 206 and the above-described cover 5 with an adhesive or the like. The frame 501 is a frame-shaped member formed around an outer periphery of the vibration absorber 206. A material of the frame 501 is, for example, a metal.

In such a chip 20, when the driving element E contracts due to energization, the diaphragm 204 is bent and deflected in such a way as to reduce a volume of the pressure chamber C0, and a force inside the pressure chamber C0 increases, causing ink droplets to be ejected from the nozzle N. At this time, a pressure also propagates from the pressure chamber C0 toward the throttling portion R1, and the ink also flows into the common flow path Rb through the throttling portion R1. After the ink is ejected, the driving element E is restored to an original position thereof. At this time, the ink in the common flow path Rb from the nozzle N also vibrates. Then, a meniscus of the nozzle Nis restored, and at the same time, the ink is supplied from the throttling portion R1. The ink is ejected from the nozzle N through the above-described series of operations.

The chip 20 according to the present embodiment includes all the elements illustrated in FIG. 3, but the components of the chip 20 do not need to include all the elements, and may further include additional elements.

The chip 20 has, for example, a monolithic structure, is a member thinner than the flow path opening forming member 25, and is, for example, a component having a thickness of less than 3000 μm. The chip 20 may be a component having a thickness of 1500 μm or less, or 1000 μm or less. The thickness of the chip 20 may be ⅕ or less of a length of a short side of the chip 20 when viewed in a direction along the Z axis, the direction being a thickness direction of the chip 20. Furthermore, it is sufficient if the chip 20 includes at least one element among the nozzle plate 201, the pressure chamber substrate 203, the communication plate 202 or the driving element E, and the sealing substrate 205. The chip 20 may include at least the nozzle plate 201, may further include the pressure chamber substrate 203, and may further include the communication plate 202. At least one of the nozzle plate 201, the pressure chamber substrate 203, the communication plate 202 or the pressure chamber substrate 203 on which the driving element E is stacked, and the sealing substrate 205 may be regarded as the chip 20. Further, the chip 20 may also be a stacked body of ceramic sheets or thin plates such as metal plates, or a stacked body in which thin plate-shaped members of the above-described materials are stacked, in addition to a stacked body of silicon substrates manufactured by micro-electromechanical systems (MEMS).

### 1-4. Flow Path Opening Forming Member 25

As illustrated in FIG. 4, the flow path opening forming member 25 is disposed in the Z2 direction with respect to the chip 20. The flow path opening forming member 25 has the through-hole 21H. The through-hole 21H overlaps a through-hole 20H of the sealing substrate 205 in plan view. The wiring substrate 209 is inserted into the through-hole 21H.

A flow path 25R is formed inside the flow path opening forming member 25. The flow path 25R is provided to supply the ink to the chip 20. The space Rc is provided on a chip 20 side of the flow path 25R, that is, the space Rc is provided downstream of the flow path 25R. The flow path 25R and the space Rc communicate with each other.

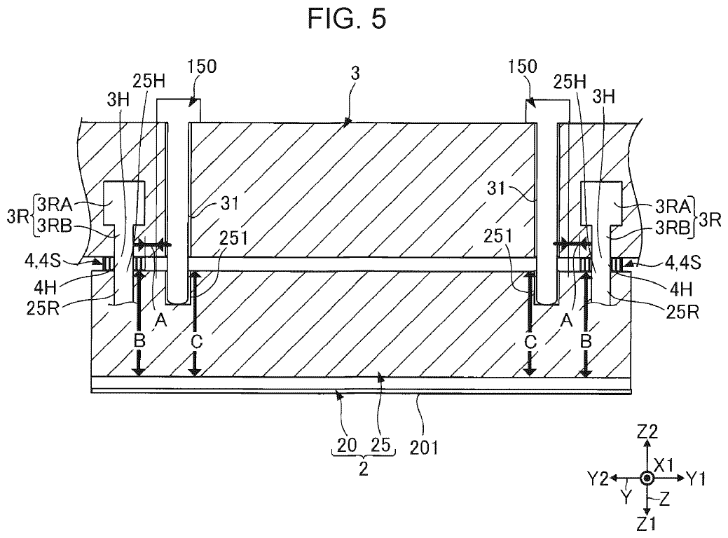

FIG. 5 is a view illustrating the head module 2, the supply flow path member 3, and the sealing member 4 illustrated in FIG. 2. As illustrated in FIG. 5, the flow path 25R of the flow path opening forming member 25 has a plurality of flow path openings 25H on a side of the flow path 25R that is opposite to the chip 20, that is, the plurality of flow path openings 25H are provided upstream of the flow path 25R. Therefore, the flow path openings 25H are formed in the flow path opening forming member 25. Each flow path opening 25H is an opening end of the flow path 25R in the Z2 direction. The flow path openings 25H are openings for coupling the flow path 25R of the flow path opening forming member 25 of the head module 2 and a flow path 3R of the supply flow path member 3 described below.

The flow path opening forming member 25 also has a plurality of fixing holes 251. The fixing holes 251 are bottomed holes provided on a surface of the flow path opening forming member 25 that faces the Z2 direction, and can also be considered as recesses, that is, depressions. A fixing member 150 for fixing the head module 2 and the supply flow path member 3 is inserted into each fixing hole 251.

Although not illustrated, a planar shape of the flow path opening forming member 25 is approximately equal to a planar shape of the chip 20.

### 1-5. Supply Flow Path Member 3

As illustrated in FIG. 5, the supply flow path member 3 includes the flow path 3R. The flow path 3R supplies the ink to each head module 2 and distributes the ink to each head module 2. The flow path 3R is a common flow path that is common to the plurality of head modules 2, and includes a common portion 3RA extending along the X axis and a plurality of branch portions 3RB branching from the common portion 3RA and extending in the Z1 direction. Although not illustrated, a flow path joint for communicating with the liquid storage section 9 via the flow path member 60 is provided on the supply flow path member 3. The flow path joint is exposed to the outside of the liquid ejecting head 1, for example, through an opening (not illustrated) formed in the supply flow path member 3.

A flow path opening 3H is provided on a head module 2 side of the flow path 3R, that is, the flow path opening 3H is provided downstream of the flow path 3R. The flow path opening 3H is an opening end of the flow path 3R in the Z1 direction. The flow path opening 3H is provided corresponding to the flow path opening 25H described above.

Further, the supply flow path member 3 also has a plurality of fixing holes 31. Each fixing hole 31 is a hole that penetrates through the supply flow path member 3 in a direction along the Z axis, the direction being a thickness direction of the supply flow path member 3. The fixing member 150 is inserted into each fixing hole 31.

The fixing member 150 fixes the supply flow path member 3 and the flow path opening forming member 25. The fixing member 150 is, for example, a screw. In this case, a female screw is formed on each inner peripheral wall surface on which the fixing hole 251 is formed. Since the fixing member 150 is a screw, the supply flow path member 3 and the flow path opening forming member 25 can be easily fixed and released by rotating and screwing the screw. Furthermore, since the fixing member 150 is a screw, the flow path opening forming member 25 can be detachably fixed to the supply flow path member 3 without using an adhesive.

The fixing member 150 may be a member other than a screw, and may include, for example, an L-shaped or T-shaped pin whose tip in the Z1 direction is bent at a right angle and an elastic member such as a leaf spring or a coil spring, and may be configured to fix the supply flow path member 3 and the flow path opening forming member 25 by using an elastic force of the elastic member.

### 1-6. Sealing Member 4

As illustrated in FIG. 5, each sealing member 4 has a communication port 4H. The communication port 4H is provided corresponding to the flow path opening 25H of the flow path opening forming member 25 and the flow path opening 3H of the supply flow path member 3. Although not illustrated in detail, the communication port 4H overlaps each of the flow path opening 3H and the flow path opening 25H when viewed in the Z1 direction. The communication port 4H is coupled to the flow path 25R via the flow path opening 25H. The communication port 4H is coupled to the flow path 3R via the flow path opening 3H. Therefore, the flow path 25R and the flow path 3R communicate with each other via the communication port 4H.

The sealing member 4 is a member that is sandwiched between the head module 2 and the supply flow path member 3 in the Z1 direction, thereby liquid-tightly coupling the flow path opening 25H of the head module 2 and the flow path opening 3H of the supply flow path member 3. The sealing member 4 is compressed between the flow path opening forming member 25 and the supply flow path member 3, so that the flow path 25R and the flow path 3R communicate with each other via the communication port 4H. The ink flowing through the flow path 3R of the supply flow path member 3 flows into the flow path 25R of the flow path opening forming member 25 via the communication port 4H, and is supplied to the individual flow path of the chip 20 via the common space R.

The sealing member 4 also has a sealing region 4S. In the present embodiment, the entire region of the sealing member 4 corresponds to the sealing region 4S. The sealing region 4S is in contact with both the flow path opening forming member 25 and the supply flow path member 3 and is a region of the sealing member 4 that is sandwiched between the flow path opening forming member 25 and the supply flow path member 3. The sealing region 4S is a region that is compressed by a load from the flow path opening forming member 25 and the supply flow path member 3 in order to liquid-tightly couple the flow path opening 25H and the flow path opening 3H to each other. In other words, even when the sealing region 4S is the region of the sealing member 4 that is sandwiched between the flow path opening forming member 25 and the supply flow path member 3, a portion that is not compressed by the load from the flow path opening forming member 25 and the supply flow path member 3 and does not substantially contribute to liquid-tightly coupling the flow path opening 25H and the flow path opening 3H to each other is not included in the sealing region 4S.

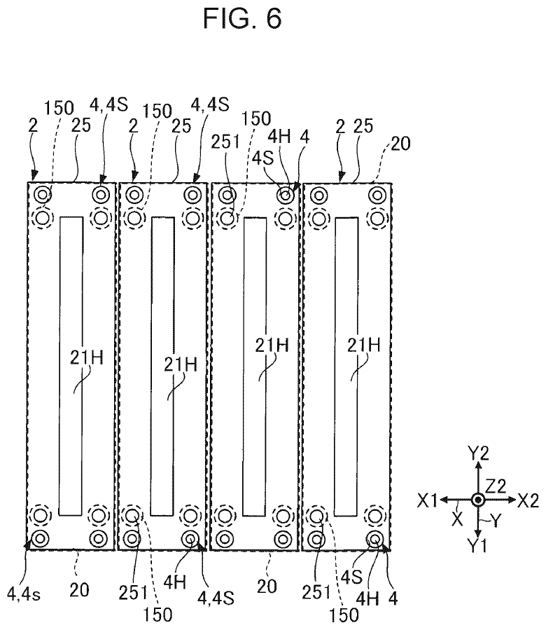

FIG. 6 is a plan view of the head module 2 and the sealing member 4 illustrated in FIG. 2. As illustrated in FIG. 6, four sealing members 4 are provided for each head module 2. The four sealing members 4 are provided at both end portions of one head module 2 in a longitudinal direction. Each sealing member 4 is circular when viewed in the Z1 direction, and may be polygonal or the like. The through-hole 21H of the flow path opening forming member 25 described above is provided at the center of the flow path opening forming member 25 in plan view. Each sealing member 4 is positioned in the Y1 direction or the Y2 direction with respect to the through-hole 21H when viewed in the Z1 direction. In the illustrated example, each sealing member 4 is disposed at a corner of a quadrangular shape when viewed in the Z1 direction.

The fixing member 150 is provided near the sealing member 4. Four fixing members 150 are provided for each head module 2. The four fixing members 150 are provided at both end portions of one head module 2 in the longitudinal direction. Each fixing member 150 is closer to the through-hole 21H than the sealing member 4 positioned in the vicinity thereof when viewed in the Z1 direction. In the illustrated example, each fixing member 150 is disposed at a corner of the quadrangular shape when viewed in the Z1 direction.

As illustrated in FIG. 6, the planar shape of the flow path opening forming member 25 is approximately equal to the planar shape of the chip 20 indicated by a broken line.

The sealing member 4 and the sealing region 4S overlap the chip 20 when viewed in the Z2 direction. Further, as illustrated in FIG. 5, the dimension B of a portion of the flow path opening forming member 25 that overlaps the sealing region 4S in the Z1 direction is larger than a distance A, which is the shortest distance between the sealing region 4S and the fixing member 150 when viewed in the Z2 direction. Therefore, the liquid ejecting head 1 can be reduced in size as compared to a case where the sealing region 4S does not overlap the chip 20, and since the dimension B is larger than the distance A, an effect of a reaction force of the sealing member 4 is less likely to act on the chip 20 as compared to a case where the dimension B is smaller than the distance A. Therefore, warping or the like is less likely to occur in the chip 20. Therefore, reliability of the head module 2 can be improved. The dimension B is a length of the portion of the flow path opening forming member 25 in the Z1 direction, the portion overlapping the sealing region 4S when viewed in the Z1 direction.

Furthermore, the fixing member 150 overlaps the chip 20 when viewed in the Z1 direction. Therefore, the liquid ejecting head 1 can be further reduced in size as compared to a case where the fixing member 150 does not overlap the chip 20.

Furthermore, the sealing region 4S and the fixing member 150 do not overlap each other when viewed in the Z2 direction, but are spaced apart from each other. Therefore, it is easier to dispose the flow path, the sealing member 4, and the fixing member 150 as compared to a case where the sealing region 4S and the fixing member 150 overlap each other.

The dimension B may be larger than twice the distance A, and may be larger than three times the distance A. As a result, it is possible to significantly exert the above-described effects.

A dimension C of a portion of the flow path opening forming member 25 that overlaps the fixing member 150 in the Z1 direction is larger than the distance A. As the dimension C is larger than the distance A, damage to the flow path opening forming member 25 at a fixing position of the fixing member 150 due to the reaction force of the sealing member 4 can be prevented as compared to a case where the dimension C is smaller than the distance A. The dimension C may be larger than twice the distance A, and may be larger than three times the distance A. Here, as illustrated in FIG. 5, the dimension C is a dimension of the largest portion of the flow path opening forming member 25 in the Z1 direction, the largest portion of the flow path opening forming member 25 overlapping the fixing member 150 when viewed in the Z1 direction. However, the dimension C may also be a dimension of the smallest portion of the flow path opening forming member 25 in the Z1 direction, the smallest portion of the flow path opening forming member 25 overlapping the fixing member 150 when viewed in the Z1 direction. In this case, the dimension C corresponds to a distance from a bottom surface of the fixing hole 251 to a tip surface of the flow path opening forming member 25 in the Z1 direction. The dimension C may be equal to or smaller than the distance A.

As described above, the liquid ejecting head 1 includes the plurality of head modules 2. For example, the head module 2 positioned at the leftmost position in FIG. 6 is a “first head module 2a”. The head module 2 positioned to the right of the first head module 2a is a “second head module 2b”. In this case, the flow path opening forming member 25 of the first head module 2a is a “first flow path opening forming member 25a”, and the flow path opening forming member 25 of the second head module 2b is a “second flow path opening forming member 25b”. The flow path opening 25H formed in the first flow path opening forming member 25a is a “first flow path opening 25Ha”, and the flow path opening 25H formed in the second flow path opening forming member 25b is a “second flow path opening 25Hb”. The chip 20 of the first head module 2a is a “first chip 20a”, and the chip 20 of the second head module 2b is a “second chip 20b”. The sealing member 4 that liquid-tightly couples the first flow path opening 25Ha and the flow path opening 3H of the supply flow path member 3 to each other between the first head module 2a and the supply flow path member 3 in the Z1 direction is a “first sealing member 4a”. The sealing member 4 that liquid-tightly couples the second flow path opening 25Hb and the flow path opening 3H of the supply flow path member 3 to each other between the second head module 2b and the supply flow path member 3 in the Z1 direction is a “second sealing member 4b”. The sealing region 4S of the first sealing member 4a is a “first sealing region 4Sa”, and the sealing region 4S of the second sealing member 4b is a “second sealing region 4Sb”. The fixing member 150 that fixes the supply flow path member 3 and the first flow path opening forming member 25a is a “first fixing member 150a”, and the fixing member 150 that fixes the supply flow path member 3 and the second flow path opening forming member 25b is a “second fixing member 150b”.

The dimension B of the portion of the first flow path opening forming member 25a sandwiched between the first chip 20a and the first sealing member 4a in the Z1 direction is a “first dimension B1”. The dimension B of the portion of the second flow path opening forming member 25b sandwiched between the second chip 20b and the second sealing member 4b in the Z1 direction is a “second dimension B2”. The distance A between the first sealing region 4Sa and the first fixing member 150a when viewed in the Z1 direction is a “first distance A1”. The distance A between the second sealing region 4Sb and the second fixing member 150b when viewed in the Z1 direction is a “second distance A2”.

The first dimension B1 is larger than the first distance A1. The second dimension B2 is larger than the second distance A2. As described above, in each of the plurality of head modules 2, the dimension B is larger than the distance A, and thus, the effect of the reaction force of the sealing member 4 is less likely to act on the chip 20 as compared to a case where the dimension B is smaller than the distance A. Therefore, the reliability of the plurality of head modules 2 can be improved, and therefore the reliability of the liquid ejecting head 1 can be improved.

### 2. Modified Examples

The first embodiment exemplified above can be modified in various ways. Specific modified aspects that can be applied to the first embodiment described above are described below by way of example. Two or more aspects arbitrarily selected from the following examples can be appropriately and compatibly combined.

### 2-1. First Modified Example

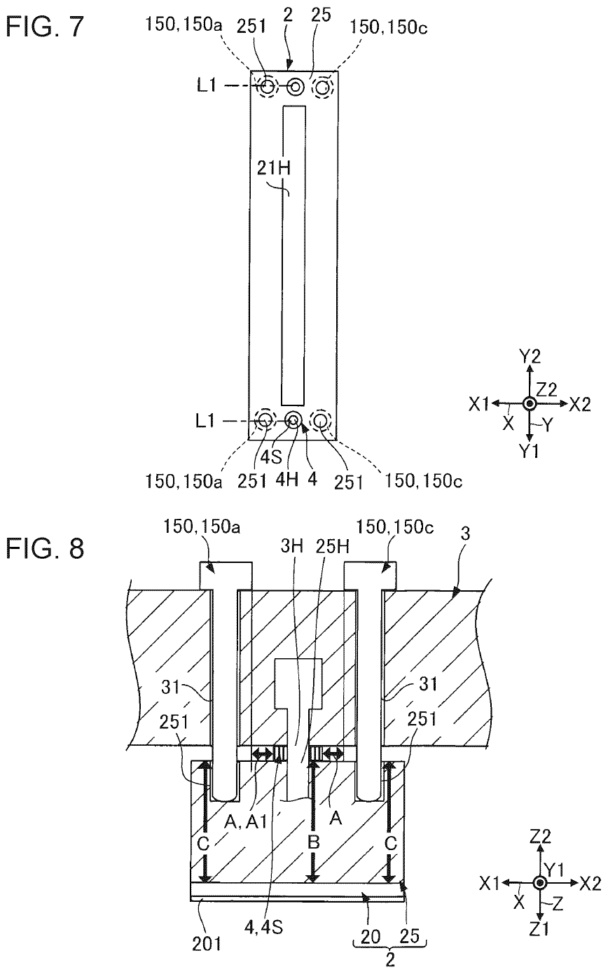

FIG. 7 is a plan view of a sealing member 4 and a fixing member 150 according to a first modified example. FIG. 8 is a cross-sectional view of the sealing member 4 and the fixing member 150 according to the first modified example. In the first modified example illustrated in FIG. 7, two sealing members 4 are provided for each head module 2. Each sealing member 4 is disposed between two adjacent fixing members 150 when viewed in the Z1 direction.

For example, in FIG. 7, the fixing member 150 positioned in the X1 direction with respect to one sealing member 4 is a “first fixing member 150a”, and the fixing member 150 positioned in the X2 direction with respect to the one sealing member 4 is a “third fixing member 150c”.

As illustrated in FIG. 8, the dimension B is larger than both a distance A (first distance A1) between a sealing region 4S and the first fixing member 150a when viewed in the Z2 direction and a distance A between the sealing region 4S and the third fixing member 150c when viewed in the Z2 direction. Therefore, it is possible to suppress the effect of the reaction force of the sealing member 4 acting on the chip 20. In addition, as illustrated in FIG. 7, the third fixing member 150c is not positioned on a half line L1 extending from the sealing region 4S toward the first fixing member 150a when viewed in the Z2 direction. With the first fixing member 150a and the third fixing member 150c, the sealing member 4 can be held down at different positions in the sealing region 4S, so that the effect of the reaction force of the sealing member 4 on the chip 20 can be effectively suppressed. The third fixing member 150c may be positioned on the half line L1.

In particular, the sealing region 4S is disposed between the first fixing member 150a and the third fixing member 150c when viewed in the Z1 direction. Therefore, it is possible to particularly effectively suppress the effect of the reaction force of the sealing member 4 acting on the chip 20.

### 2-2. Second Modified Example

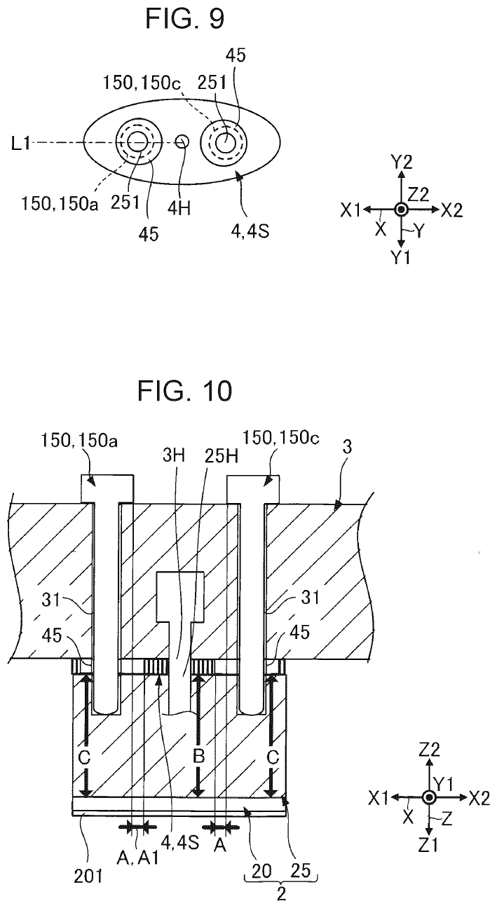

FIG. 9 is a plan view of a sealing member 4 and a fixing member 150 according to a second modified example. FIG. 10 is a cross-sectional view of the sealing member 4 and the fixing member 150 according to the second modified example. The second modified example will be mainly described with respect to the differences from the first modified example.

A planar shape of the sealing member 4 according to the second modified example illustrated in FIG. 9 is much larger than that of the first modified example. The sealing member 4 according to the second modified example has a through-hole 45 for inserting the fixing member 150. The through-hole 45 is provided for each fixing member 150. Specifically, the sealing member 4 has the through-hole 45 through which a first fixing member 150a is inserted and the through-hole 45 through which a third fixing member 150c is inserted.

Also in the present modified example, the dimension B is larger than both a distance A between a sealing region 4S and the first fixing member 150a when viewed in the Z2 direction and a distance A between the sealing region 4S and the third fixing member 150c when viewed in the Z2 direction. Therefore, it is possible to suppress the effect of the reaction force of the sealing member 4 acting on the chip 20.

### 2-3. Third Modified Example

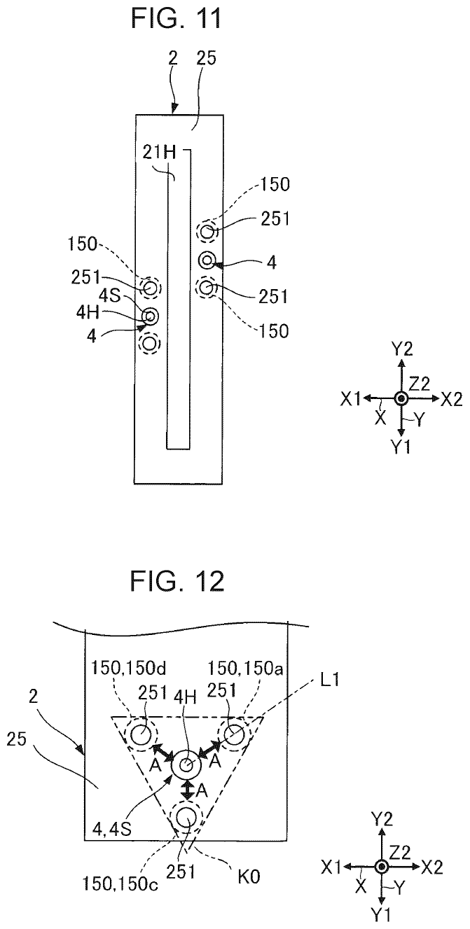

FIG. 11 is a plan view of a sealing member 4 and a fixing member 150 according to a third modified example. The third modified example will be mainly described with respect to the differences from the first modified example. In the modified example illustrated in FIG. 11, four fixing members 150 are provided at both end portions of one head module 2 in a transverse direction. Also with such an arrangement, it is possible to suppress the effect of the reaction force of the sealing member 4 acting on the chip 20.

### 2-4. Fourth Modified Example

FIG. 12 is a plan view of a sealing member 4 and a fixing member 150 according to a fourth modified example. In the fourth modified example illustrated in FIG. 12, three or more adjacent fixing members 150 are provided for one sealing member 4. Specifically, a first fixing member 150a, a third fixing member 150c, and a fourth fixing member 150d are provided. Each fixing member 150 fixes the supply flow path member 3 and the flow path opening forming member 25.

Although some detailed illustrations are omitted, for each fixing member 150, a distance A from a sealing region 4S when viewed in the Z2 direction is smaller than the dimension B. Therefore, it is possible to suppress the effect of the reaction force of the sealing member 4 acting on the chip 20.

Furthermore, as illustrated in FIG. 12, the sealing region 4S is disposed inside the smallest protruding polygon K0 that contains the plurality of fixing members 150 when viewed in the Z2 direction. Therefore, it is possible to particularly effectively suppress the effect of the reaction force of the sealing member 4 acting on the chip 20. The protruding polygon K0 is a triangle in the illustrated example. The protruding polygon K0 varies depending on the number of fixing members 150. The protruding polygon K0 circumscribes the respective fixing members 150. In addition, the number of fixing members 150 for one sealing region 4S is not particularly limited, and may be, for example, three to five.

### 2-5. Fifth Modified Example

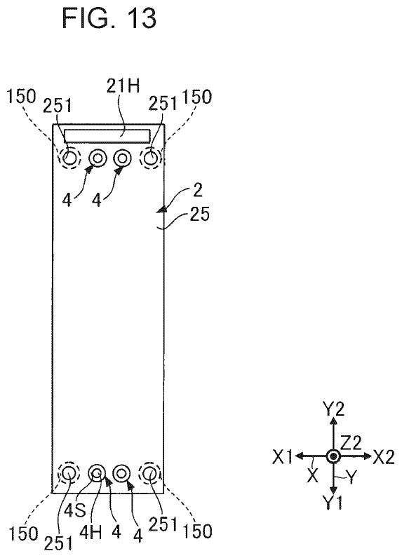

FIG. 13 is a plan view of a sealing member 4 and a fixing member 150 according to a fifth modified example. In the fifth modified example illustrated in FIG. 13, two sealing members 4 are provided between two adjacent fixing members 150. A set of two adjacent fixing members 150 and two sealing members 4 disposed between the two adjacent fixing member 150 is provided at an end portion of the head module 2 in the longitudinal direction. In addition, a through-hole 21H for inserting the wiring substrate 209 is provided at an end portion of the head module 2 in the longitudinal direction, not at the center of the head module 2, when viewed in the Z1 direction.

### 2-6. Sixth Modified Example

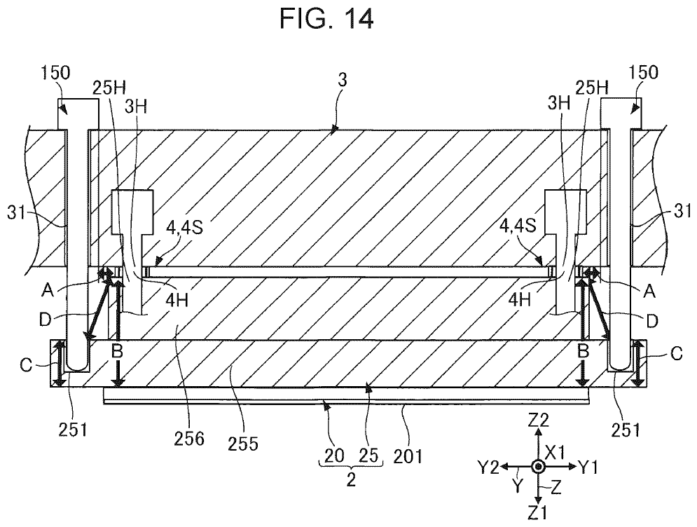

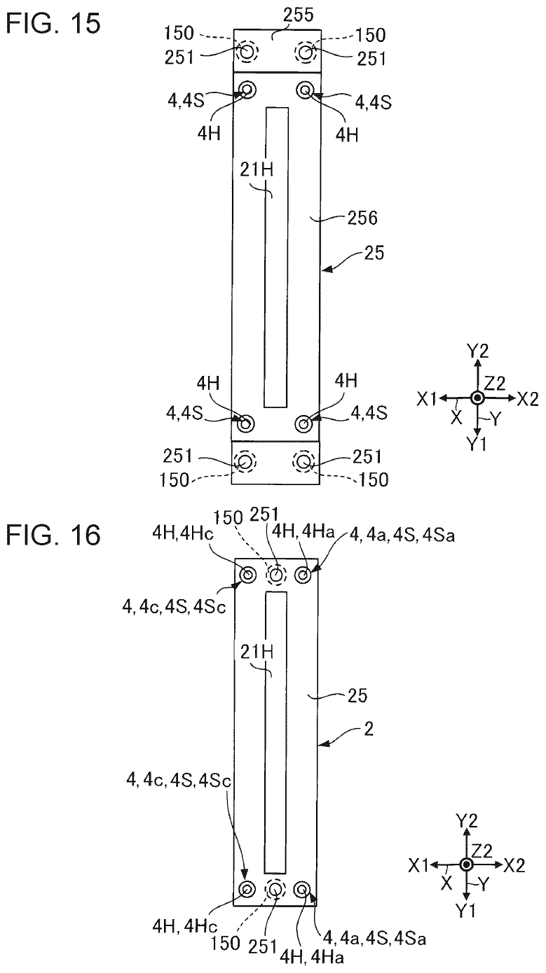

FIG. 14 is a cross-sectional view of a sealing member 4 and a fixing member 150 according to a sixth modified example. FIG. 15 is a plan view of a head module 2 according to the sixth modified example. In the sixth modified example illustrated in FIG. 14, a stepped surface is provided on a surface of a flow path opening forming member 25 of the head module 2 that faces the Z2 direction. For example, the flow path opening forming member 25 according to the sixth modified example includes a first member 255 and a second member 256. The second member 256 is disposed in the Z2 direction with respect to the first member 255. Each of the first member 255 and the second member 256 is elongated along the Y axis. Further, as illustrated in FIG. 15, a length of the first member 255 along the Y axis is larger than a length of the second member 256 along the Y axis. The first member 255 has a portion extending in the Y1 and Y2 directions with respect to the second member 256 when viewed in the Z1 direction, and the portion does not overlap the second member 256 when viewed in the Z1 direction.

A plurality of sealing members 4 are provided on a surface of the second member 256 in the Z2 direction. The plurality of sealing members 4 are provided at both end portions of the second member 256 in a longitudinal direction. A plurality of fixing holes 251 are provided at a portion of the first member 255 that does not overlap the second member 256 when viewed in the Z1 direction. Therefore, the portion of the first member 255 that does not overlap the second member 256 when viewed in the Z1 direction has a fixing position of the flow path opening forming member 25 where a fixing member 150 is fixed. As illustrated in FIG. 14, a gap equal to a length of the second member 256 along the Z axis is provided between the first member 255 and the supply flow path member 3.

Although not illustrated in detail, the second member 256 has the same shape and area as the chip 20 when viewed in the Z1 direction, and overlaps the chip 20 when viewed in the Z1 direction. On the other hand, the portion of the first member 255 that does not overlap the second member 256 when viewed in the Z1 direction does not overlap the chip 20 when viewed in the Z1 direction. Therefore, the plurality of fixing holes 251 are provided at the portion of the first member 255 that does not overlap the second member 256 when viewed in the Z1 direction, and a plurality of fixing members 150 do not overlap the chip 20 when viewed in the Z1 direction.

As illustrated in FIG. 14, in the sixth modified example, the dimension B is larger than the shortest distance D between a sealing region 4S and the fixing position of the flow path opening forming member 25 where the fixing member 150 is fixed. Therefore, it is possible to prevent twisting in the rotation direction from the fixing position of the flow path opening forming member 25 as a base point as compared to a case where the dimension B is smaller than the shortest distance D.

For example, when the fixing member 150 is a screw, the fixing position is a location where a fixing force of the fixing member 150 acts directly on the flow path opening forming member 25, such as a contact position between the fixing member 150 and an edge that forms an opening of the fixing hole 251 of the flow path opening forming member 25. The dimension B may be equal to or smaller than the shortest distance D.

Also in the present modified example, the dimension B is larger than a distance A between the sealing region 4S and the first fixing member 150a when viewed in the Z2 direction. Therefore, it is possible to suppress the effect of the reaction force of the sealing member 4 acting on the chip 20.

### 2-7. Seventh Modified Example

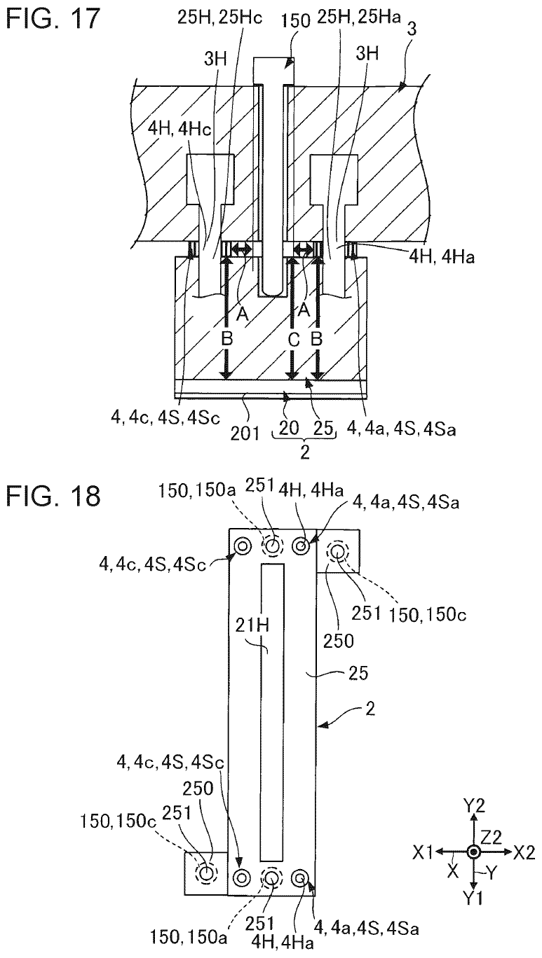

FIG. 16 is a plan view of a sealing member 4 and a fixing member 150 according to a seventh modified example. FIG. 17 is a cross-sectional view of the sealing member 4 and the fixing member 150 according to the seventh modified example. In the seventh modified example illustrated in FIGS. 16 and 17, one fixing member 150 is provided between two sealing members 4 adjacent to each other when viewed in the Z1 direction.

For example, one of the two sealing members 4 adjacent to each other when viewed in the Z1 direction is a “first sealing member 4a”, and the other is a “third sealing member 4c”. In this case, a sealing region 4S of the first sealing member 4a is a “first sealing region 4Sa”, and a sealing region 4S of the third sealing member 4c is a “third sealing region 4Sc”. In addition, a communication port 4H of the first sealing member 4a is a “first communication port 4Ha”, and a communication port 4H of the third sealing member 4c is a “third communication port 4Hc”. The flow path opening 25H of the flow path opening forming member 25 communicating with the first communication port 4Ha is a “first flow path opening 25Ha”, and the flow path opening 25H of the flow path opening forming member 25 communicating with the third communication port 4Hc is a “third flow path opening 25Hc”. The first sealing member 4a and the third sealing member 4c are disposed between the first flow path opening forming member 25a, which is the same flow path opening forming member 25, and the supply flow path member 3. The first sealing region 4Sa and the third sealing region 4Sc overlap the chip 20 when viewed in the Z1 direction.

In the seventh modified example, the first sealing member 4a and the third sealing member 4c are fixed in a state of being sandwiched between the flow path opening forming member 25 and the supply flow path member 3 by the fixing member 150 disposed between the first sealing member 4a and the third sealing member 4c. A dimension B of a portion of the flow path opening forming member 25 that overlaps the first sealing region 4Sa in the Z1 direction is larger than a distance A between the first sealing region 4Sa and the first fixing member 150a when viewed in the Z1 direction. Similarly, a dimension B of a portion of the flow path opening forming member 25 that overlaps the third sealing region 4Sc in the Z1 direction is larger than a distance A between the third sealing region 4Sc and the first fixing member 150a when viewed in the Z1 direction.

In this way, one fixing member 150 is used for fixing of both of the first sealing member 4a and the third sealing member 4c, and each dimension B is larger than the distance A. Therefore, the liquid ejecting head 1 can be reduced in size as compared to a case where the fixing member 150 and the sealing member 4 are provided in a one-to-one relationship.

### 2-8. Eighth Modified Example

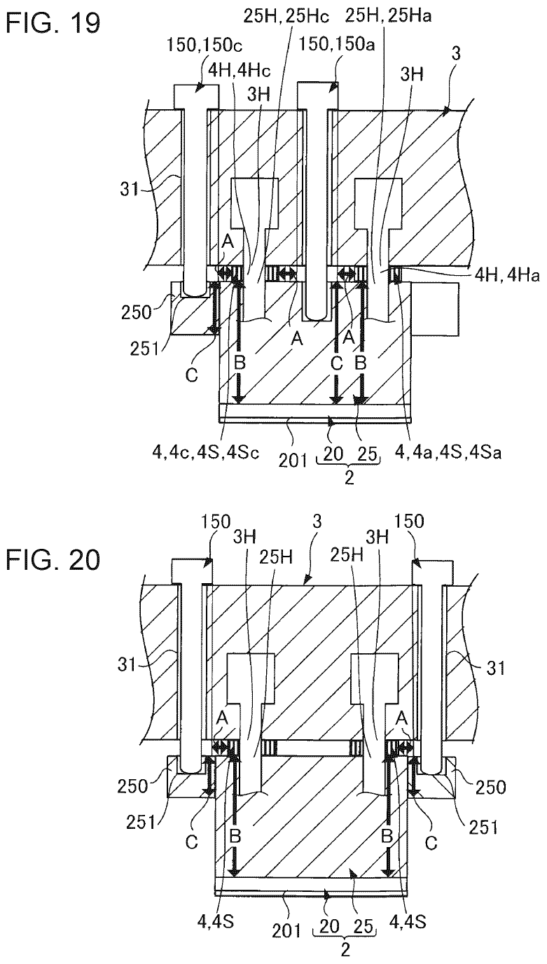

FIG. 18 is a plan view of a head module 2 according to an eighth modified example. FIG. 19 is a cross-sectional view of the head module 2 according to the eighth modified example. The eighth modified example will be mainly described with respect to the differences from the seventh modified example.

Two flange portions 250 are coupled to a flow path opening forming member 25 of the head module 2 according to the eighth modified example illustrated in FIGS. 18 and 19. The two flange portions 250 are provided at corner portions of the flow path opening forming member 25 that face each other when viewed in the Z1 direction. Each flange portion 250 protrudes from the flow path opening forming member 25 in the X1 direction or the X2 direction. A surface of each flange portion 250 in the Z2 direction and a surface of the flow path opening forming member 25 in the Z2 direction are substantially flush with each other. A thickness of each flange portion 250, which is a length of the each flange portion 250 along the Z axis, is smaller than a thickness of the flow path opening forming member 25.

In the eighth modified example, one fixing member 150 is provided between two sealing members 4 adjacent to each other when viewed in the Z1 direction. This fixing member 150 is a “first fixing member 150a”. In addition, another fixing member 150 is provided on one flange portion 250. The fixing member 150 is a “third fixing member 150c”. The first fixing member 150a, the two sealing members 4, and the third fixing member 150c are positioned on a line segment along the X axis.

Similarly, a dimension B of a portion of the flow path opening forming member 25 that overlaps the third sealing region 4Sc in the Z1 direction is larger than a distance A between the third sealing region 4Sc and the third fixing member 150c when viewed in the Z1 direction. Also with such an arrangement, it is possible to suppress the effect of the reaction force of the sealing member 4 acting on the chip 20.

### 2-9. Ninth Modified Example

FIG. 20 is a cross-sectional view of a head module 2 according to a ninth modified example. The ninth modified example will be mainly described with respect to the differences from the eighth modified example. In the ninth modified example illustrated in FIG. 20, two flange portions 250 positioned on the same line segment along the X axis are provided in a flow path opening forming member 25. Each flange portion 250 is regarded as a part of the flow path opening forming member 25. The fixing member 150 is provided on each flange portion 250. In the ninth modified example, unlike the eighth modified example, the fixing member 150 is not provided between the two sealing members 4. Even with such a configuration, the dimension B is larger than the distance A. Therefore, it is possible to suppress the effect of the reaction force of the sealing member 4 acting on the chip 20.

### 2-10. Tenth Modified Example

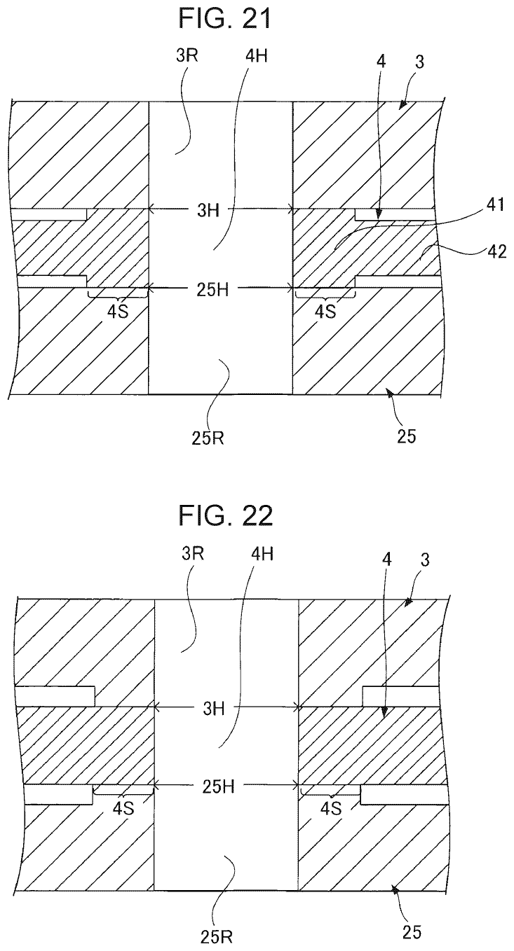

FIG. 21 is a cross-sectional view of a sealing member 4 and the vicinity thereof according to a tenth modified example. A thickness of the sealing member 4 according to the tenth modified example illustrated in FIG. 21 is not uniform. The sealing member 4 according to the tenth modified example includes a thick portion 41 and a thin portion 42. The thick portion 41 is positioned near an inner wall surface that forms a communication port 4H, and is thicker than the thin portion 42. The thin portion 42 is positioned on an outer side of the thick portion 41.

In the tenth modified example, the thick portion 41 of the sealing member 4 has a sealing region 4S. The thick portion 41 is in contact with the flow path opening forming member 25 and the supply flow path member 3, and is sandwiched between the flow path opening forming member 25 and the supply flow path member 3.

### 2-11. Eleventh Modified Example

FIG. 22 is a cross-sectional view of a sealing member 4 and the vicinity thereof according to an eleventh modified example. The sealing member 4 according to the eleventh modified example illustrated in FIG. 22 has a portion that is not in contact with both the supply flow path member 3 and the flow path opening forming member 25. The sealing member 4 according to the eleventh modified example has a sealing region 4S in the vicinity of a communication port 4H. As described above, the sealing member 4 may have a portion that is not in contact with both the supply flow path member 3 and the flow path opening forming member 25 and is not sandwiched between the supply flow path member 3 and the flow path opening forming member 25 depending on the shapes of the supply flow path member 3 and the flow path opening forming member 25. The portion of the sealing member 4 that is not sandwiched between the supply flow path member 3 and the flow path opening forming member 25 corresponds to the sealing region 4S.

### 2-12. Twelfth Modified Example

In the first embodiment described above, the supply flow path member 3 in which the flow path 3R is formed and the flow path opening forming member 25 are directly fixed by the fixing member 150, but the present disclosure is not limited thereto. The supply flow path member 3 may be configured such that a portion in which the flow path 3R is formed and a portion fixed to the flow path opening forming member 25 via the fixing member 150 are separate from each other.

### 2-13. Other Modified Examples

The “liquid ejecting apparatus” can be adopted in various devices such as a facsimile machine and a copy machine in addition to a device dedicated to printing. The use of the liquid ejecting apparatus is not limited to printing. For example, the liquid ejecting apparatus that ejects a solution of a coloring material is used as a producing apparatus that forms a color filter of a display apparatus such as a liquid crystal display panel. Further, the liquid ejecting apparatus that ejects a solution of a conductive material is used as a producing apparatus that forms a wiring or electrode of a relay substrate. Further, the liquid ejecting apparatus that ejects a solution of organic matter related to a living body is used as, for example, a producing apparatus that produces a biochip.

Although the present disclosure has been described above based on the exemplary embodiments, the present disclosure is not limited to the above-described embodiments. Further, a configuration of each portion according to the present disclosure can be substituted with an appropriate configuration that can implement the same functions as the above-described embodiments, and any appropriate configuration can also be added.

What is claimed is:

1. A liquid ejecting head comprising:
a first head module that is configure to eject a liquid in a first direction and includes a first flow path opening forming member in which a first flow path opening is formed, and a first chip disposed in the first direction with respect to the first flow path opening forming member;
a supply flow path member that supplies the liquid to the first head module;
an elastic first sealing member that is sandwiched between the first head module and the supply flow path member in the first direction to liquid-tightly couple the first flow path opening and a flow path opening of the supply flow path member to each other; and
a first fixing member that fixes the supply flow path member and the first flow path opening forming member,
wherein a first sealing region sandwiched between the first flow path opening forming member and the supply flow path member in the first sealing member overlaps the first chip when viewed in the first direction, and
a first dimension of a portion of the first flow path opening forming member that overlaps the first sealing region in the first direction is larger than a first distance between the first sealing region and the first fixing member when viewed in the first direction.

2. The liquid ejecting head according to claim 1, wherein the first dimension is larger than twice the first distance.

3. The liquid ejecting head according to claim 2, wherein the first dimension is larger than three times the first distance.

4. The liquid ejecting head according to claim 1, wherein the first fixing member overlaps the first chip when viewed in the first direction.

5. The liquid ejecting head according to claim 1, wherein a dimension of a portion of the first flow path opening forming member that overlaps the first fixing member in the first direction is larger than the first distance.

6. The liquid ejecting head according to claim 1, further comprising a third fixing member that fixes the supply flow path member and the first flow path opening forming member,
wherein the first dimension is larger than a distance between the first sealing region and the third fixing member when viewed in the first direction, and the third fixing member is not positioned on a half line extending from the first sealing region toward the first fixing member when viewed in the first direction.

7. The liquid ejecting head according to claim 6, wherein the first sealing region is disposed between the first fixing member and the third fixing member when viewed in the first direction.

8. The liquid ejecting head according to claim 6, further comprising a plurality of fixing members which include three or more fixing members including the first fixing member and the third fixing member, of which a distance to the first sealing region is smaller than the first dimension when viewed in the first direction, and which fix the supply flow path member and the first flow path opening forming member,
wherein the first sealing region is disposed inside a smallest protruding polygon that contains the plurality of fixing members when viewed in the first direction.

9. The liquid ejecting head according to claim 1, further comprising an elastic third sealing member that is sandwiched between the first head module and the supply flow path member in the first direction to liquid-tightly couple the third flow path opening and the flow path opening of the supply flow path member to each other, wherein
the third flow path opening is formed in the first flow path opening forming member,
a third sealing region sandwiched between the first flow path opening forming member and the supply flow path member in the third sealing member overlaps the first chip when viewed in the first direction, and
a dimension of a portion of the first flow path opening forming member that overlaps the third sealing region in the first direction is larger than a distance between the third sealing region and the first fixing member when viewed in the first direction.

10. The liquid ejecting head according to claim 1, wherein the first sealing region and the first fixing member do not overlap each other when viewed in the first direction.

11. The liquid ejecting head according to claim 1, wherein the first dimension is larger than a shortest distance between the first sealing region and a fixing position of the first flow path opening forming member where the first fixing member is fixed.

12. The liquid ejecting head according to claim 1, further comprising:
a second head module that includes a second flow path opening forming member in which a second flow path opening is formed, and a second chip disposed in the first direction with respect to the second flow path opening forming member;
an elastic second sealing member that is sandwiched between the second head module and the supply flow path member in the first direction to liquid-tightly couple the second flow path opening and the flow path opening of the supply flow path member to each other; and
a second fixing member that fixes the supply flow path member and the second flow path opening forming member,
wherein a second sealing region sandwiched between the second flow path opening forming member and the supply flow path member in the second sealing member overlaps the second chip when viewed in the first direction, and
a second dimension of a portion of the second flow path opening forming member that is sandwiched between the second chip and the second sealing member in the first direction is larger than a second distance between the second sealing region and the second fixing member when viewed in the first direction.

13. A liquid ejecting apparatus comprising:
a plurality of the liquid ejecting heads according to claim 1; and
a unit base to which the plurality of liquid ejecting heads are fixed.
